(19) United States
(12) Patent Application Publication
(10) Pub. No.: US 2008/0130114 A1
(43) Pub. Date: Jun. 5, 2008

(54) OPTICAL PLATE HAVING THREE LAYERS

(75) Inventors: TUNG-MING HSU, Tu-Cheng (TW); SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/623,302

(22) Filed: Jan. 15, 2007

(30) Foreign Application Priority Data
Dec. 1, 2006 (CN) 200610201196.6

(51) Int. Cl. G02B 5/02

(52) U.S. Cl. 359/599; 359/831

(57) ABSTRACT

An exemplary optical plate includes a first transparent layer, a second transparent layer and a light diffusion layer. The light diffusion layer is between the first and second transparent layers. The light diffusion layer, the first and second transparent layers are integrally formed. The light diffusion layer includes a transparent matrix resin and a plurality of diffusion particles dispersed in the transparent matrix resin. The first transparent layer includes a plurality of V-shaped protrusions at an outer surface distalmost from the second transparent layer. The second transparent layer includes a plurality of spherical protrusions at an outer surface distalmost from the first transparent layer.

### BACKGROUND OF THE INVENTION

1. Field of the Invention

The present invention generally relates to optical plates, and more particularly, to an optical plate for use in, for example, a liquid crystal display (LCD).

2. Discussion of the Related Art

The lightness and slimness of LCD panels make them suitable for use in a wide variety of electronic devices such as personal digital assistants (PDAs), mobile phones, portable personal computers, and other electronic appliances. Liquid crystal is a substance that does not itself emit light. Instead, the liquid crystal relies on receiving light from a light source in order to display images and data. In the case of a typical LCD panel, a backlight module powered by electricity supplies the needed light.

FIG. 5 is an exploded, side cross-sectional view of a typical backlight module 10 employing a typical optical diffusion plate. The backlight module 10 includes a housing 11, a plurality of lamps 12 disposed on a base of the housing 11 for emitting light rays, and a light diffusion plate 13 and a prism sheet 15 stacked on a top of the housing 11 in that order. The housing 11 is configured for reflecting certain of the light rays upwards. The light diffusion plate 13 includes a plurality of dispersion particles. The dispersion particles are configured for scattering the light rays, and thereby enhancing the uniformity of light output from the light diffusion plate 13. This can correct what might otherwise be a narrow viewing angle experienced by a user of a corresponding LCD panel. The prism sheet 15 includes a plurality of V-shaped structures at a top thereof.

In use, light rays from the lamps 12 enter the prism sheet 15 after being scattered in the light diffusion plate 13. The light rays are refracted in the prism sheet 15 and concentrated by the V-shaped structures so as to increase brightness of light illumination, and finally propagate into an LCD panel (not shown) disposed above the prism sheet 15. The brightness may be improved by the V-shaped structures, but the viewing angle may be narrowed. In addition, even though the light diffusion plate 13 and the prism sheet 15 abut each other, a plurality of air pockets still exists at the boundary between them. When the backlight module 10 is in use, light passes through the air pockets, and some of the light undergoes total reflection at one or another of the interfaces at the air pockets. As a result, the light energy utilization ratio of the backlight module 10 is reduced.

Therefore, a new optical means is desired in order to overcome the above-described shortcomings.

### SUMMARY

An optical plate includes a first transparent layer, a second transparent layer and a light diffusion layer. The light diffusion layer is laminated between the first and second transparent layers. The light diffusion layer, the first and second transparent layers are integrally formed. The light diffusion layer includes a transparent matrix resin and a plurality of diffusion particles dispersed in the transparent matrix resin. The first transparent layer includes a plurality of V-shaped protrusions at an outer surface distalmost from the second transparent layer. The second transparent layer includes a plurality of spherical protrusions at an outer surface distalmost from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate. Moreover, in the drawings, like reference numerals designate corresponding parts throughout the several views, and all the views are schematic.

FIG. 1 is an isometric view of an optical plate in accordance with a first embodiment of the present invention.

FIG. 2 is a cross-sectional view of the optical plate of FIG. 1, taken along line II-II thereof.

FIG. 3 is a side cross-sectional view of an optical plate in accordance with a second embodiment of the present invention.

FIG. 4 is a side cross-sectional view of an optical plate in accordance with a third embodiment of the present invention.

FIG. 5 is an exploded, side cross-sectional view of a conventional backlight module.

### DETAILED DESCRIPTION OF THE EMBODIMENTS

Reference will now be made to the drawings to describe preferred embodiments of the present optical plate, in detail.

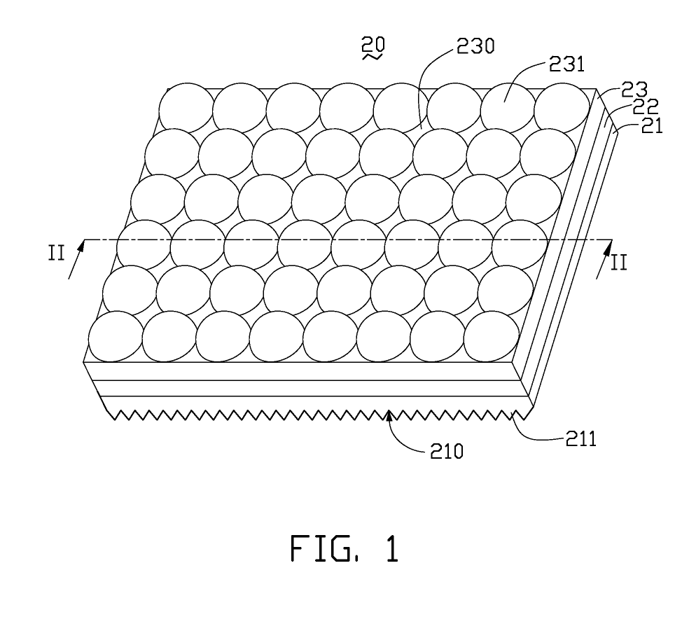

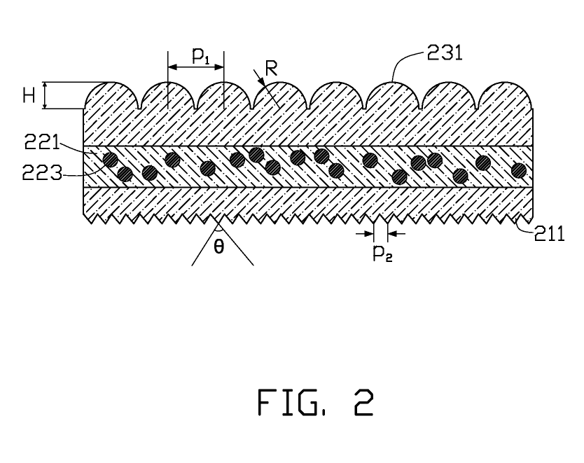

Referring to FIGS. 1 and 2, an optical plate 20 according to a first embodiment is shown. The optical plate 20 includes a first transparent layer 21, a light diffusion layer 22, and a second transparent layer 23. The first transparent layer 21, the light diffusion layer 22, and the second transparent layer 23 are integrally formed, with the light diffusion layer 22 being between the first and second transparent layers 21, 23. The first transparent layer 21 and the light diffusion layer 22 are in immediate contact with each other at a common interface thereof. Similarly, the second transparent layer 23 and the light diffusion layer 22 are in immediate contact with each other at a common interface thereof. This kind of unified body with no gaps in the common interfaces can be made by, for example, two-shot injection molding or three-shot injection molding. The first transparent layer 21 defines a plurality of V-shaped protrusions 211 protruding out from an outer surface 210 thereof distalmost from the second transparent layer 23. The second transparent layer 23 defines a plurality of spherical protrusions 231 at an outer surface 230 thereof distalmost from the first transparent layer 21.

In the illustrated embodiment, each of the V-shaped protrusions 211 is substantially an elongated prism (or ridge) that extends along a direction parallel to a side surface of the optical plate 20. The V-shaped protrusions 211 are arranged side by side and are parallel to each other on the outer surface 210 of the first transparent layer 21. A pitch P₂ between two adjacent V-shaped protrusions 211 is in the range from about 0.025 millimeters to about 1 millimeter. A vertex angle θ of each V-shaped protrusion 211 is in the range from about 60 degrees to about 120 degrees. It is to be understood that the V-shaped protrusions 211 may be configured otherwise. For example, each of the V-shaped protrusions 211 can instead be a right-angled triangle prism, with one face of the prism parallel to the side surface of the optical plate 20, and another face of the prism generally facing toward but slanted relative to an opposite side surface of the optical plate 20.

The spherical protrusions 231 are configured for collimating the emitted light rays, thus improving a brightness of light illumination. In the illustrated embodiment, each spherical protrusion 231 is substantially a hemisphere. The spherical protrusions 231 are aligned regularly on the light output surface 230 in a matrix arrangement, with adjacent spherical protrusions 231 being separated from each other a small distance. In order to obtain a good optical effect, a radius R of each of the spherical protrusions 231 is in the range from about 0.01 millimeters to about 3 millimeters. A height H of the spherical protrusions 231 with respect to the light output surface 230 is in the range from about 0.01 millimeters to the radius value R. A pitch P₁ between centers of two adjacent spherical protrusions 231 is in the range R/2≦P₁≦4 R. Accordingly, the pitch P₁ is in the range from about 5 microns to about 12 millimeters. In the illustrated embodiment, the height H is equal to the radius R, and the pitch P₁ is greater than 2 R. It is to be understood that, each spherical protrusion 231 can be replaced by a similar protrusion that is smaller than a hemisphere. That is, each spherical protrusion 231 can instead be sub-hemispherical.

A thickness of each of the first transparent layer 21, the light diffusion layer 22, and the second transparent layer 23 may be greater than or equal to 0.35 millimeters. In a preferred embodiment, a combined thickness of the first transparent layer 21, the light diffusion layer 22, and the second transparent layer 23 may be in the range from about 1.05 millimeters to about 6 millimeters. Each of the first transparent layer 21 and the second transparent layer 23 can be made of transparent matrix resin selected from the group consisting of polyacrylic acid (PAA), polycarbonate (PC), polystyrene (PS), polymethyl methacrylate (PMMA), methylmethacrylate and styrene (MS), and any suitable combination thereof. It should be noted that the materials of the first and second transparent layers 21, 23 may be the same or may be different.

The light diffusion layer 22 includes a transparent matrix resin 221, and a plurality of diffusion particles 223 uniformly dispersed in the transparent matrix resin 221. The light diffusion layer 22 is configured for enhancing an optical uniformity of the optical plate 20. The transparent matrix resin 221 is selected from the group consisting of polyacrylic acid (PAA), polycarbonate (PC), polystyrene (PS), polymethyl methacrylate (PMMA), methylmethacrylate and styrene (MS), and any combination thereof. The diffusion particles 223 can be made of material selected from the group consisting of titanium dioxide, silicon dioxide, acrylic resin, and any combination thereof. The diffusion particles 223 are configured for scattering light rays and enhancing the uniformity of light exiting the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 223.

It should be noted that when the optical plate 20 is used in a direct type backlight module, either the first transparent layer 21 or the second transparent layer 23 of the optical plate 20 can be arranged to face a light source of the backlight module. Light rays from the light source enter the optical plate 20 via the first transparent layer 21 or the second transparent layer 23. The backlight module may further include a housing to receive the light source, with the optical plate 20 positioned above a top of the housing.

When the light rays enter the optical plate 20 via the first transparent layer 21, the light rays are diffused by the V-shaped protrusions 211 of the first transparent layer 21. Then the light rays are further substantially diffused in the light diffusion layer 22 of the optical plate 20. Finally, many or most of the light rays are condensed by the spherical protrusions 231 of the second transparent layer 23 before they exit the optical plate 20. As a result, a brightness of the backlight module can be increased. In addition, the light rays are diffused at two levels, so that an optical uniformity of the optical plate 20 is enhanced. Furthermore, the first transparent layer 21, the light diffusion layer 22, and the second transparent layer 23 are integrally formed together (see above), with no air or gas pockets trapped in the respective interfaces therebetween. Thus the efficiency of utilization of light rays is increased. Moreover, when the optical plate 20 is assembled into a backlight module, the optical plate 20 in effect replaces the conventional combination of a diffusion plate and a prism sheet. Therefore compared with conventional art, a process of assembly of the backlight module is simplified and the efficiency of assembly is improved. Still further, in general, a space occupied by the optical plate 20 is less than that occupied collectively by the conventional combination of a diffusion plate and a prism sheet. Thus a size of the backlight module can also be reduced.

When the light rays enter the optical plate 20 via the second transparent layer 23, the optical uniformity of the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle of the backlight module is somewhat larger than that of the backlight module when the light rays enter the optical plate 20 via the second transparent layer 23.

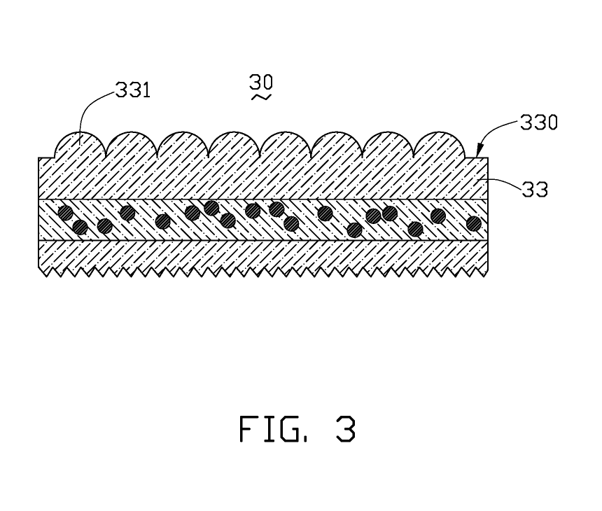

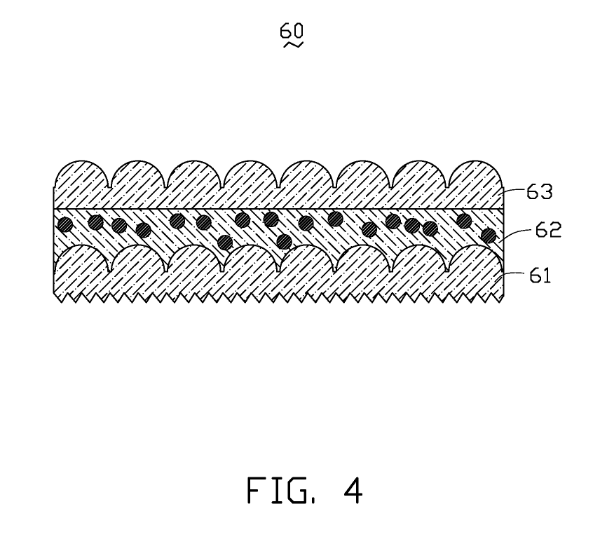

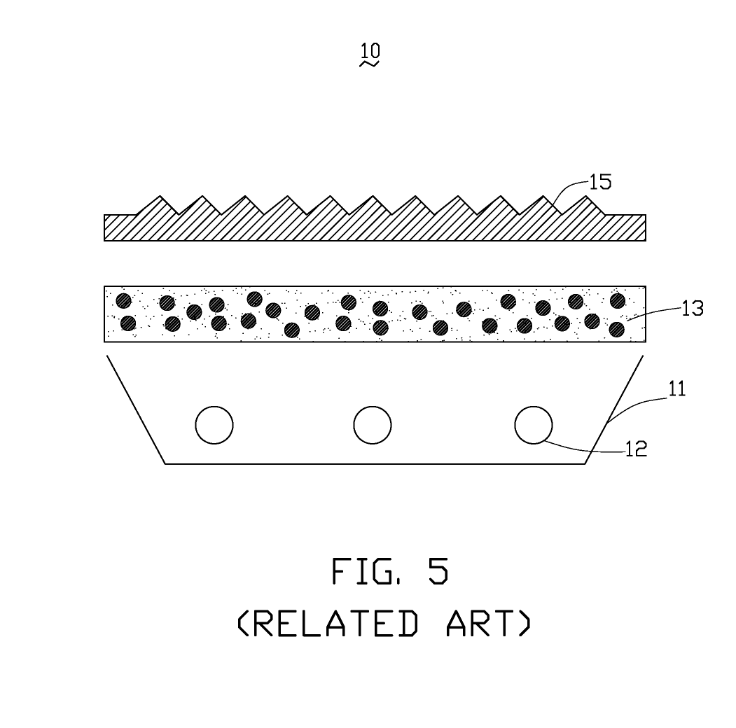

Referring to FIG. 3, an optical plate 30 according to a second embodiment is shown. The optical plate 30 is similar in principle to the optical plate 20 of the first embodiment. However, in the optical plate 30, spherical protrusions 331 are arranged side by side on outer surface 330 of a second transparent layer 33 in a matrix, with adjacent spherical protrusions 331 adjoining each other.

In the above-described embodiments, an interface between the light diffusion layer and the first transparent layer is flat. Similarly, an interface between the light diffusion layer and the second transparent layer is flat. In one kind of alternative embodiment, the interface between the light diffusion layer and the first transparent layer may be non-planar. One example if this kind of configuration is given below.

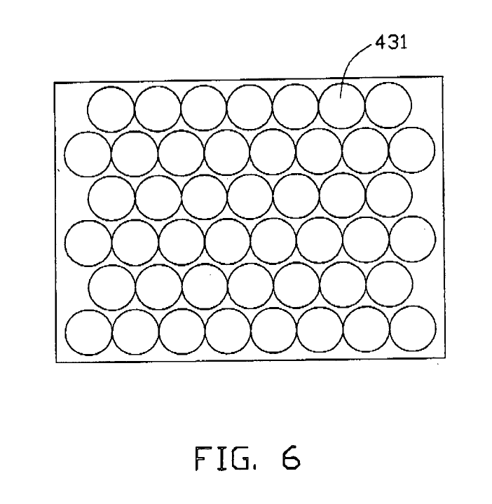

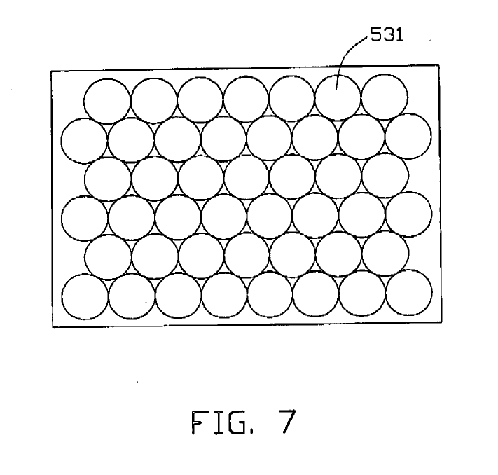

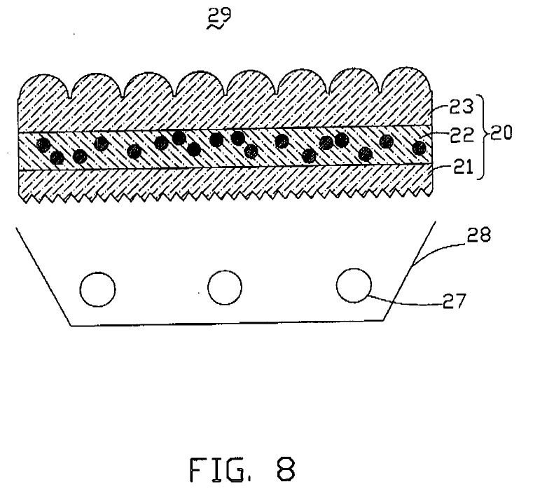

Referring to FIG. 4, an optical plate 60 according to a third embodiment is shown. The optical plate 60 includes a first transparent layer 61, a light diffusion layer 62, and a second transparent layer 63. The optical 60 is similar in principle to the optical plate 20 of the first embodiment, except that an interface (not labeled) between the first transparent layer 61 and the light diffusion layer 62 is a wavy interface. Therefore, a binding strength between the first transparent layer 61 and the light diffusion layer 62 can be increased.

It should be understood that the spherical protrusions of the above-described optical plates are not limited to being aligned in a regular matrix. The alignment can be otherwise. In one example, the spherical protrusions 231, 331 in any two adjacent rows of spherical protrusions 231, 331 can be staggered relative to each other, with a rectangular area occupied by each row of spherical protrusions 231, 331 not overlapping a rectangular area occupied by each of adjacent rows of spherical protrusions 231, 331. Thus a matrix comprised of offset rows of the spherical protrusions 231, 331 is formed. In another example, the spherical protrusions 231, 331 in any two adjacent rows of spherical protrusions 231, 331 can be staggered relative to each other, but with each spherical protrusion 231, 331 in each row of spherical protrusions 231, 331 close to or abutting two adjacent spherical protrusion 231, 331 in each of the adjacent rows of spherical protrusions 231, 331. In a further example, the spherical protrusions 231, 331 can be arranged randomly on the outer surface of the second transparent layer.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, and the first transparent layer comprises a plurality of V-shaped protrusions at an outer surface thereof farthest from the second transparent layer and the second transparent layer comprises a plurality of spherical protrusions at an outer surface thereof farthest from the first transparent layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer, and the second transparent layer is in the range from about 1.05 millimeters to about 6 millimeters.

4. The optical plate as claimed in claim 1, wherein each of the first and second transparent layers is made of material selected from the group consisting of polyacrylic acid, polycarbonate, polystyrene, polymethyl methacrylate, methylmethacrylate and styrene, and any combination thereof.

5. The optical plate as claimed in claim 1, wherein a pitch between two adjacent V-shaped protrusions is in the range from about 0.025 millimeters to about 1 millimeter.

6. The optical plate as claimed in claim 5, wherein a vertex angle of each V-shaped protrusion is in the range from about 60 degrees to about 120 degrees.

7. The optical plate as claimed in claim 1, wherein a pitch between two adjacent spherical protrusions is in the range from about 5 microns to about 12 millimeters.

8. The optical plate as claimed in claim 1, wherein the spherical protrusions are arranged regularly on the outer surface of the second transparent layer in a matrix.

9. The optical plate as claimed in claim 8, wherein the spherical protrusions are arranged on the outer surface of the second transparent layer in rows, and the spherical protrusions in each row of spherical protrusions are staggered relative to the spherical protrusions in each of the adjacent rows of spherical protrusions.

10. The optical plate as claimed in claim 9, wherein a rectangular area occupied by each row of spherical protrusions does not overlap a rectangular area occupied by each of the adjacent rows of spherical protrusions.

11. The optical plate as claimed in claim 9, wherein each spherical protrusion in each row of spherical protrusions is close to or abuts two adjacent spherical protrusions in each of the adjacent rows of spherical protrusions.

12. The optical plate as claimed in claim 1, wherein at least one of the following interfaces is flat: an interface between the light diffusion layer and the first transparent layer, and an interface between the light diffusion layer and the second transparent layer.

13. The optical plate as claimed in claim 1, wherein at least one of the following interfaces is starved non-planar: an interface between the light diffusion layer and the first transparent layer, and an interface between the light diffusion layer and the second transparent layer.

14. The optical plate as claimed in claim 1, wherein the transparent matrix resin of the light diffusion layer is made of material selected from the group consisting of polyacrylic acid, polycarbonate, polystyrene, polymethyl methacrylate, methylmethacrylate and styrene, and any combination thereof.

15. The optical plate as claimed in claim 1, wherein a material of the diffusion particles is selected from the group consisting of titanium dioxide, silicon dioxide, acrylic resin, and any combination thereof.

16. The optical plate as claimed in claim 1, wherein the spherical protrusions are selected from the group consisting of hemispherical protrusions and sub-hemispherical protrusions.

17. A direct type backlight module, comprising:
a housing;
a plurality of light sources disposed on or above a base of the housing; and
an optical plate disposed above the light sources, the optical plate comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, and the first transparent layer comprises a plurality of V-shaped protrusions at an outer surface thereof farthest from the second transparent layer, and the second transparent layer comprises a plurality of spherical protrusions at an outer surface thereof farthest from the first transparent layer.

18. The direct type backlight module as claimed in claim 17, wherein a selected one of the first transparent layer and the second transparent layer of the optical plate is arranged to face the light sources, such that light rays from the light sources enter the optical plate via the corresponding first transparent layer or second transparent layer.
